(19) United States
(12) Patent Application Publication
(10) Pub. No.: US 2003/0007489 A1
(43) Pub. Date: Jan. 9, 2003

(54) Data extraction system for packet analysis

(76) Inventors: Ram Krishnan, Laguna Niguel, CA (US); Noah Hudson, Long Beach, CA (US); Huan Luu, Aliso Viejo, CA (US)

Correspondence Address: Chad W. Miller, Weide & Associates, Ltd., Phoenix Bldg.,11th Floor, Suite 1130, 330 South 3rd Street, Las Vegas, NV, 89101, US

(21) Appl. No.: 09/902,229

(22) Filed: Jul. 9, 2001

(51) Int. Cl. H04L 12/56

(52) U.S. Cl. 370/392; 370/469

(57) ABSTRACT

A method and apparatus for extracting information from an item of data is disclosed. In one embodiment, the invention operates within a packet processing device such as a router. Upon receipt of a data item the data item is analyzed to obtain information regarding the protocol under which the data item was constructed. Different protocol locate relevant processing and routing information at different offsets in a data item's header. As a result of the analysis, the system obtains a protocol key used to identify or obtain offset parameters. In one embodiment the results of the analysis are masked and the protocol key provided to a content addressable memory to identify the offset parameters. Using the offset parameters identified by the protocol key, the system selectively copies portions of the data item to generate a search key. The search key contains information pertinent to processing. The search key is provided to a table device or look-up device to obtain processing information for the data item being processed. In one embodiment the table device comprises a content addressable memory. In one embodiment the invention provides a high speed packet analysis system configured to generate a search key for use in a route table. Use of high speed table devices achieves high speed operation with configurability and flexibility by user input and modification to the look-up devices.

### FIELD OF THE INVENTION

The present invention relates to data item analysis and in particular methods and apparatus for packet analysis.

### BACKGROUND OF THE INVENTION

A popular method for exchanging data between computers or data processing systems is to group or break the data into packets or data items and transmit the data items over a channel to one or more other data processing systems. The data processing systems and the channel may be considered a computer network. At times, the data item may have to pass through or hop between one or more intermediate data processing systems, such as routers, before reaching its final destination. For purposes of discussion, the sending system is referred to as a source station, the receiving system is referred to as a destination station, (collectively end stations) while intermediate systems or relay points are referred to as nodes. It is contemplated that each node may include numerous ports, each of which connects to a separate channel. One example of a node is a router. One example of this topology is a packet switched network.

Each data item may be comprised of a header and a payload. One example of a data item is a packet. The header comprises data indicating the source and destination of the data item, the type of service or any other various information as may be desired to associated with the data item. The payload comprises the data or information that is being sent to a different location or exchanged between end stations.

The data item may assume one of several different formats or protocols. Over time, different protocols have been developed to adapt to the changing needs and requirements of computer networks. The protocol determines how the data item, and in particular the header, is arranged. For example, the destination address may reside at a different location in the header depending on the particular protocol of the data item.

At various nodes in the network the header or other similar aspect of the data item is analyzed so that the node may determine how to process the data item. For example, the destination of the data item may need to be analyzed to select an output port on which to forward the data item.

In systems of the prior art, such as those that process packets in a packet switched network, the header analysis is performed by a CPU operating in association with software. Upon receipt of a data item, the header may be analyzed by the CPU to obtain header information for use in processing the packet.

The packet analysis has traditionally been performed using complex software algorithms to perform software functions on header data to find the required data. The CPU executes memory read operations to obtain the desired header information from the packet stored in memory.

The methods and systems of the prior art suffer from many drawbacks. One such drawback is that prior art methods and systems require an undesirably long period of time to execute the desired operation. As technology advances, increases in network channel data transmission rates have outpaced advances in CPU and software capability. Attempts have been made to optimize search algorithms but the steps of accessing memory is a cycle consuming process. As a result, the processing has become a bottleneck in the transmission of payload data over packet switched networks.

The present invention overcomes the drawbacks and limitations of the prior art by providing a method and apparatus for header analysis and header information extraction.

### SUMMARY OF THE INVENTION

The invention provides a method and apparatus for data item, such as a packet, processing and data extraction for use in processing of the packet. The invention provides a method and apparatus to obtain and use a robust, content rich search key having greater data capacity than the prior art methods and as a result, yields more robust and content rich packet processing control instructions. The results of the processing may provide control instructions to assist in packet routing, priority assignment, drop assignment, queue assignment, multicast or simulcast assignments, input control monitoring data, output monitoring control data, and potential modifications to the packet.

In one embodiment, a method for processing a packet to determine packet routing information comprises receiving a packet such as a packet having a header and a payload. Thereafter, copying at least a portion of the first two bytes of the header. It is contemplated that the within the first two bytes of a header is information that reveals the arrangement of the header. Desired header information may be located at different locations in different protocols. Next, the method inputs at least a portion of the first two bytes of the header into a first content addressable memory or other look-up device. The first content addressable memory may be configured to output header data extraction parameters to control the extraction of packet processing control data from the header of the packet. Next, the method copies at least a portion of the header to obtain packet processing control data, such that in one embodiment the portions copied are controlled at least in part by the header data extraction parameters. In one embodiment 32 bits of data, copied from any location(s) within the packet, may be used to perform protocol classification. The method then inputs the packet processing control data into a second content addressable memory or other look-up device that is configured to output packet routing information to control routing of the packet. In various embodiments the header data extraction parameters comprise one or more offset values from the beginning of the packet header. The header may include at least a portion of a tag. In one embodiment, the first content addressable memory and the second content addressable memory are embodied in a single content addressable memory device. In one embodiment the method further includes masking at least a portion of the first two bytes of the header.

In another example method of operation, the invention is designed to identify a protocol and generate a search key by extracting a portion of a data item to obtain protocol information and providing the protocol information to a look-up device to obtain data item configuration information. The data item configuration information is indicative of the location of data within the data item. Next, the method extracts processing information from the data item based on the data item configuration information and provides the processing information to a look-up device to obtain data item handling information. In one embodiment the method applies a mask to the protocol information prior to providing the protocol information to the look-up device to obtain data item configuration information and applies a mask to the processing information prior to providing the processing information to a look-up device to obtain data item handling information. The look-up device may comprise a content addressable memory. In some protocols, the protocol information is contained within at least a portion of the first byte of the data item.

The invention may be embodied in hardware, software, or a combination thereof. In one embodiment, the invention is embodied as a system for extracting header data from a packet such as for use in processing the packet. The system may comprise a first state machine configured to extract protocol data from the packet. A first look-up device is in communication with the protocol key extraction device and is configured to match the protocol data to obtain offset parameters. A second state machine is configured to receive the offset parameters and extract search key data from the packet based on the offset parameters. A second look-up device is in communication with the search key extraction device and configured to match the search key data to obtain packet processing control data. In one embodiment the first and second look-up devices comprise content addressable memory. In one embodiment the first and second state machines comprise a single state machine. The offset parameters may define the location within the packet of the search key data.

Further objects, features, and advantages of the present invention over the prior art will become apparent from the detailed description of the drawings which follows, when considered with the attached figures.

### DESCRIPTION OF THE DRAWINGS

FIG. 1 illustrates an example packet.

FIG. 2 illustrates an example header configuration.

FIG. 3 illustrates an example packet with a tag.

FIGS. 4A and 4B illustrate an exemplary process diagram of an example process of one embodiment of the invention.

FIG. 5 illustrates a block diagram of one example embodiment of the invention.

FIG. 6 illustrates a block diagram of one example embodiment of a data extraction mechanism.

FIG. 7 illustrates an operational flow diagram of an example method of operation.

### DESCRIPTION OF THE INVENTION

The invention is a method and apparatus for protocol analysis and header information extraction. In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention

Example Environment

One example environment of the invention is within in a packet switched network configured to link a plurality of computers. Located throughout the packet switched network are various switches, hubs and routers. Although the invention is suited for use and would provide benefit to any device configured to analyze or process packets, one particular implementation of the invention is in a packet routing device in a network, such as a packet switched network. It should be noted that the term processing device, such as a router, is defined to mean any device capable of analyzing a data item and selecting between two or more different processing options for the data item based on the analysis. In addition, the term network is defined to mean any configuration of one or more electronic devices configured to exchange data or information, including any computer, communication, or data network currently in use or that may be developed in the future. The term data item is defined to mean any amount or assembly of data (payload) that includes supplemental data, such as for example a header, that provides supplemental information regarding the payload in the data item.

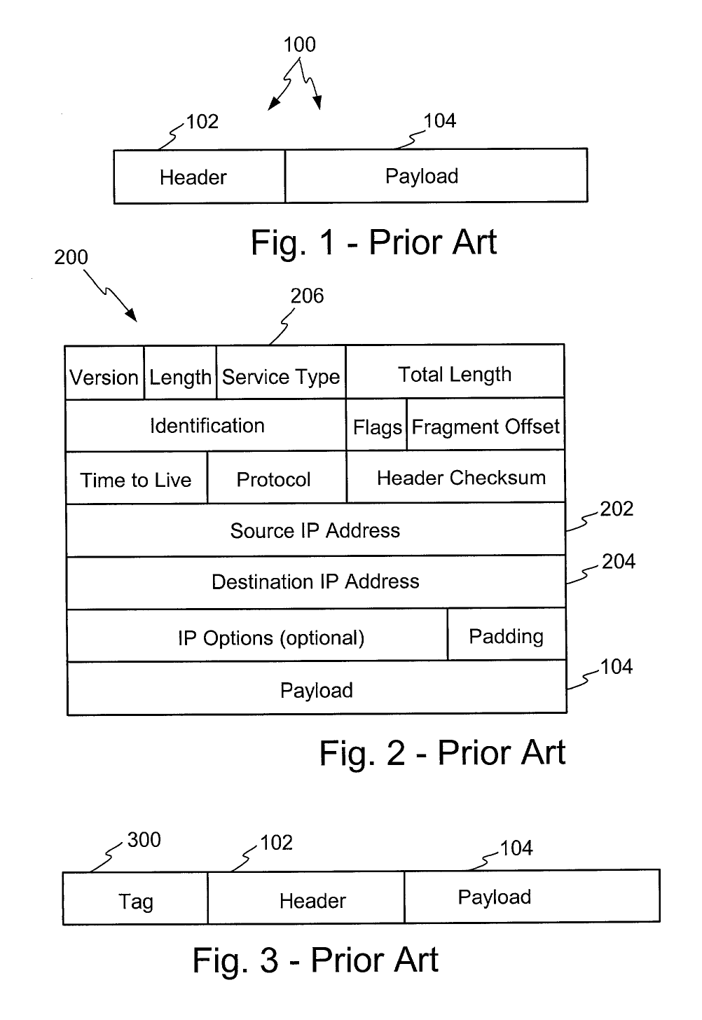

In a typical network a plurality of computers communicate by forming data for transmission into packets. FIG. 1 illustrates a packet 100 having a header portion 102 and a payload portion 104. The packet 100 is one example of a data item. FIG. 2 illustrates an example configuration of the packet 100. As can be seen from FIG. 2, the header may contain information useful for routing the packet such as source information 202, destination information 204, type of service information 206 and other information. As shown in FIG. 3, it is further contemplated that a tag may be attached to the header portion 102 of the packet. The term header 300 should be interpreted broadly to optionally include a tag.

It is contemplated by the inventors that different packets may have different header configurations depending on the method or protocol under which the packet was constructed. For example, packets constructed under a first protocol may arrange the header data in different order and assigned different field sizes to the various fields of the header than a second protocol. Yet another protocol may eliminate certain fields, as compared to the first protocol, or add additional fields to the header. Examples of various packet protocols include IPv4, IPv6, and DiffServ. It is further contemplated that protocols other than these may be created in the future. Similarly, other packets may be configured with supplemental information attached, such as a tag or other configuration. Moreover, it is contemplated that in the future different methods and configurations for transmitting data may be enabled that share a need to analyzed a portion of the data or header to effectuate processing decisions and processing. These new methods may also benefit from the invention described herein.

After the packet is constructed, that is data is encapsulated with an associated header, it is transmitted onto the network. At various processing locations in the network the packet may be analyzed to achieve processing of the packet. At a processing location comprising a router, numerous input lines and output lines converge with packets flowing inwardly to and outward from the router. The router analyzes the header of the packet to select on which of the numerous output lines the packet is to be transmitted. In this manner the packet progresses through the network unit it reaches its intended destination.

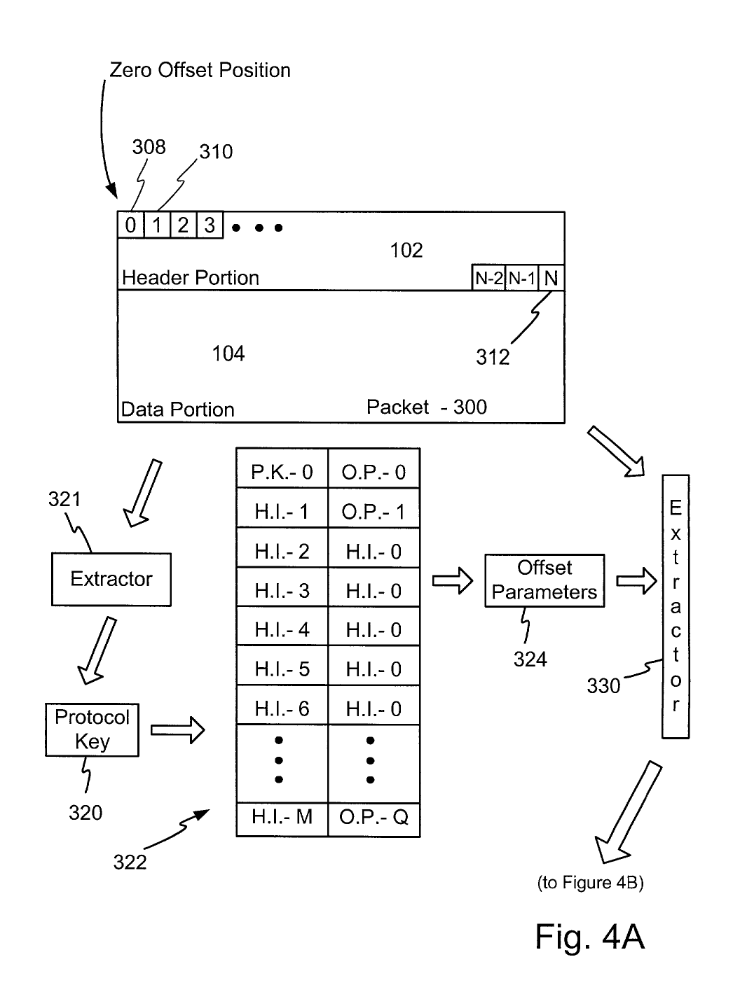

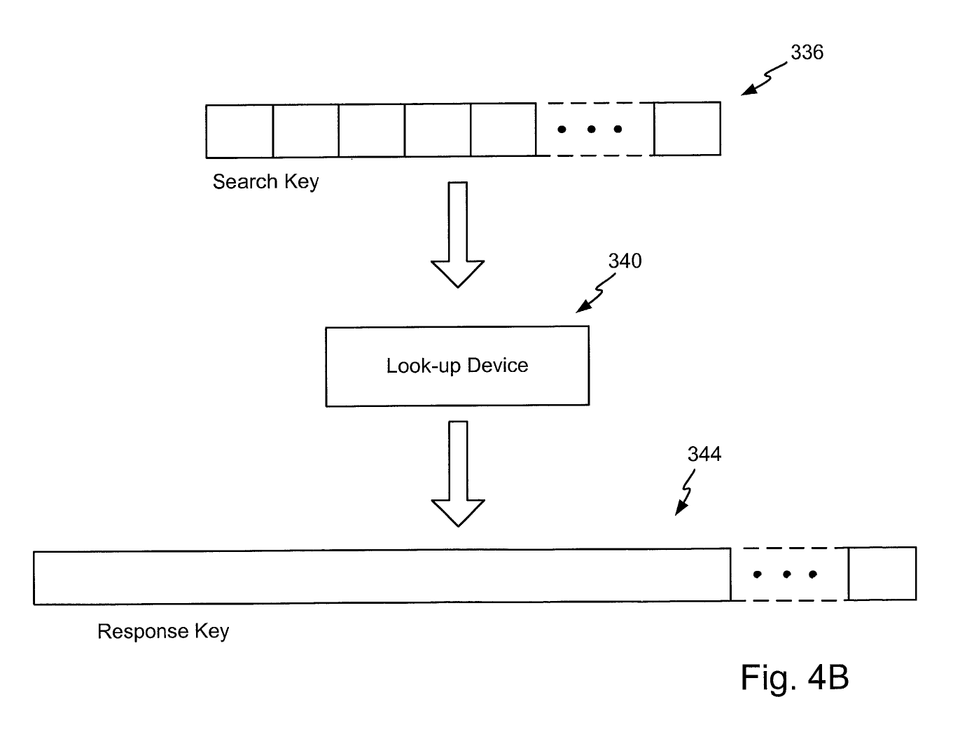

Turning now to operation of one embodiment of the invention described in the example implementation of a router. Upon receipt of a packet the router performs input processing as is understood by those of ordinary skill in the art. A general method of operation of an example embodiment of the invention is now described. In reference to FIG. 4A a process diagram of one example embodiment of the invention is shown. A packet 300 is received at a routing device. In the example embodiment described herein the packet includes a header portion 102 and a payload portion 104. In one embodiment the data contained in the header may be identified by a unit offset from the first unit. In one embodiment the unit offset comprises a bit and the first unit is the first bit of the packet 100. In another embodiment the unit offset comprises a nibble. In another embodiment the unit offset comprises a byte. In another embodiment the unit offset comprises a word.

A first offset position 308 is defined as zero offset from the start of the packet. A second offset position 310 is defined one unit offset from the start of the packet 300. The offsets, in this embodiment from the start of the packet, can be used to define the position or location of header information within the packet. The offset continues through to an offset N 312. It is further contemplated that the data in the payload portion 104 may also be identified by an offset and may be optionally extracted.

Processing of the packet reveals a protocol key 320. The extraction of the header data from the packet is described below in greater detail. As shown in FIG. 4B, processing may comprise analysis by an extractor 321 of data from the packet that is indicative of the protocol of the packet. The protocol key 320 may comprise a portion of the packet header. In one embodiment the protocol key 320 comprises the first two bytes of the header or a portion thereof. In another embodiment the protocol key 320 comprises a portion of a tag attached to the packet 300. In general, the protocol key 320 comprise header information obtained from the packet that provides an indication of the content or arrangement of the header. Different protocols may arrange header fields in different configurations, and, as a result, the protocol key 320 may be used to determine the protocol under which a packet header was constructed and hence the location of relevant data in a packet header.

In one embodiment, a mask is applied to the protocol key to further limit the size of the protocol key or to selectively identify the desired portions of the protocol key. The broad concept of masking to selectively utilize a portion of the data is generally understood and accordingly not described in great detail herein.

The protocol key 320 is provided to a look-up device 322 to obtain offset parameters 324. The offset parameters 324 comprise offset values regarding the offset from the start of the packet header at which relevant data is located in the header. Relevant data comprises data that is useful for packet processing. In another embodiment the offset parameter 324 does not define an offset, but a different means to locate or identify data within a packet. In one embodiment the offset parameters 324 comprise thirty-two offset values with each of the thirty-two values defining an offset from the start of the packet at which relevant information is located. In one embodiment the offset values specify data from the first 1024 nibbles of the packet. In another embodiment the offset value can select data from the first 512 bytes of the packet.

The look-up or table device 322, when provided with the protocol key (P.K.), locates a matching value and outputs corresponding offset parameters (O.P.) 324. The table device 322 may comprise any device or system capable of receiving an input and, upon matching the input against a list of possible matches, providing as an output a value or data associated with the match. The offset parameter 324 is not limited to thirty-two values as it may comprise more or fewer values. In one embodiment a closest match is acceptable instead of an exact match.

The output of the look-up device 322 provides the offset parameter to an extractor 330. In one embodiment, the offset parameters 324 control the location in the packet at which the extractor 330 copies data from the packet. The copied data forms the search key 336, which is shown in FIG. 4B.

In one embodiment the extractor 330 selects a nibble as the unit of extraction. In an other embodiment the unit of extraction comprises a bit. In an other embodiment the unit of extraction comprises a byte. In an other embodiment the unit of extraction comprises a word. In other embodiments other amount of data may be extracted.

Hence, in one example embodiment the extractor 330 sequentially extracts a nibble of data from the packet at the locations specified by the offset parameter. In one embodiment the location specified in the offset parameter 324 is an offset from the start of the packet header or the start of the packet tag. Thus, at each of the thirty-two offset parameters, the extractor 330 copies a nibble of data to form the search key 336.

Turning now to FIG. 4B, a continuation of the process diagram on the example embodiment is further illustrated. The example search key 336 as might be generated by the extractor 330 may comprise a string of data configured to contain relevant information regarding the packet. The search key 336 comprises any amount or configuration of data as is desired to perform a search based on the content of the search key 336. In one embodiment the search key contains data from the pocket that is used to perform a look-up.

As shown in FIG. 4B, the search key 336 may be provided to a look-up device 340. In one embodiment the search key 336 comprises an input to a route table for route or next hop look-up. In one embodiment the search key 336 comprises 128 bits of information. As an advantage over the prior art, the search key 336 can be of any length. In one embodiment the size of the search key 336 is the same as the input width of the look-up device 340. As a result, if the look-up process occurs at high speed, the entire search key may be processed in a single operation and as a result rapidly yield a response key in a single operation. In systems of the prior art, large amounts of data required more memory cycles or processor cycles to process. Moreover, because the search key 336 may be generated in high speed and may be of any length, the current invention allows a more content rich search key to be generated. This results in complex matching in the look-up device 340 and more robust and feature rich searches and search results. More fields may be limited or interjected to the search thereby providing more route and processing options and capabilities. The search key may comprise data from any portion of the header or payload to thereby create an information rich key that can be used in detailed search operations. In one example embodiment the search key includes information regarding type of service information or type of content instead of or in addition to destination, route or the protocol of the packet. In broad terms, the ‘content’ of the packet may be analyzed and processing may occur based on the ‘content.’ Hence in one embodiment the invention may be trained or configured to recognize the content or application specific information and perform functions based on the content or application specific information. As a result, exemplary packets containing telephone call information, streaming video, or e-mail, or arriving over a particular port, may be handled differently and as flexibly controlled by an administrator. Other options are contemplated and can be performed by the invention.

It is further contemplated that the search key 336 may be masked to selectively identify portions of the search key for use or matching by the look-up device 340. Masking a string or set of data to isolate or utilize only a portion of the set is generally understood and hence not described in detail herein. Masking provides at least the advantage of selectively utilizing select portions of the search key 336 thereby providing flexibility to the invention. In one embodiment the designation of the mask is software controlled, possibly via a user interface. Hence, user selectability is provided in a high speed system that does not suffer from the software/processor drawbacks of the prior art.

It is contemplated that the search key 336 is provided to the look-up device 340 to execute a search or other matching process to locate a value associated with a match or closest match to the search key. The look-up device 340 comprises any apparatus or system capable of matching the input with a stored value and outputting one or more associated values. In one embodiment the look-up device 340 comprises a content addressable memory. Any look-up, table, or matching device may be used to implement the invention. It is desired that the look-up device 340 operate at sufficient speed to thereby not slow system operation.

For purposes of discussion, the look-up device 340 output is referred to as a response key 344. In one embodiment the response key 344 comprises a sixteen byte data string. In one embodiment the response key 344 comprises data that at least controls the next-hop destination of the packet. One advantage of the invention over the prior art is that the invention may provide a more robust output based on the search key 336. As a result, more complete and flexible packet routing or processing may occur. In addition, in some embodiments information beyond basic packet routing information may be provided by the input of the search key 336 to the look-up device 340 and the output from the look-up device. By way of example and not limitation, a robust response key 344 may contain information regarding port number or port information, multicast/simulcast fields, priority, queue selection or virtual queue selection, packet discardability, input monitoring and control data, output monitoring and output control data, and packet modification rules or requirements. The response key 344 may contain other types of information beyond the categories previously listed. It should be noted that an advantage of the invention comprises its flexibility. The content of response key 344 may comprise any data or information as may be desired by a user. The invention is not limited to the use of the response for a particular purpose.

The content of the look-up device, table device or matching device is user programable or controlled and may be modified automatically by software or user interface. Hence the invention provides flexibility, yet high speed operation while the actual process, once selected and set up, occurs at least partially in hardware. In one embodiment, the entire process, once set-up and the look-up device populated, occurs without any software and/or processor activity. This provides speed advantages over the prior art.

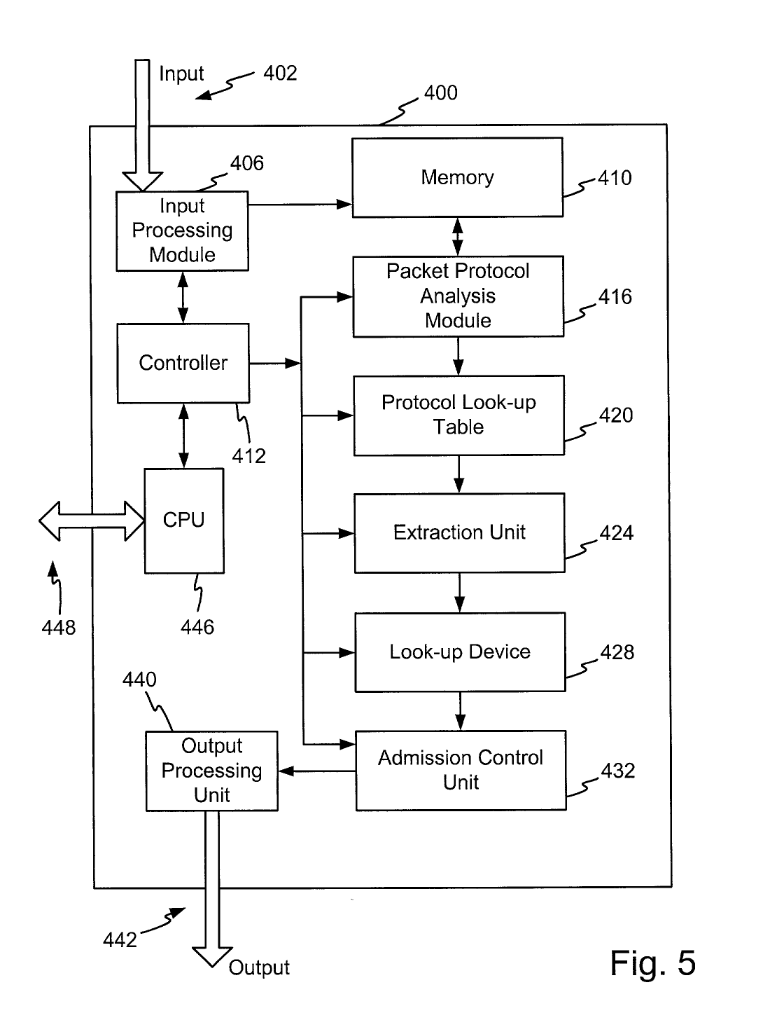

FIG. 5 illustrates a block diagram of an example configuration of the invention. In this embodiment a processing device is configured as a packet router 400. In other embodiments the invention may be realized in configurations other than a router. The router 400 includes one or more input lines or ports 402 that connect to an input processing module 406. The input processing module 406 performs processing as is known in the art for receiving data from a transmission line and preparing the data for analysis.

In the embodiment shown, the input processing module 406 connects to a memory 410. The memory 410 may store the packet during analysis and processing. The memory may comprise any type of memory capable of storing digital data. In one embodiment the memory comprises SDRAM. In other embodiments the memory 410 comprises RAM, DRAM, RDRAM, flash memory, optical memory, disk drive, or any combination of these types of memories. The input processing module 406 also connects to a controller 412 The controller comprises logic and other hardware configured to operate at high speed. The controller 412, if comprised of control logic, may be integrated throughout the router 400 as required to achieve operation. In one embodiment the controller 412 comprises a state machine. In another embodiment the controller 412 comprises a compilation of logic that may be interspersed through the system.

The memory 410 also connects to a packet protocol analysis module 416 as does the controller 412. The controller 412 also connects to or is in communication with a protocol look-up table 420, an extraction module 424, a look-up device 428, an admission control unit 432 and an output processing module 440. An output of the packet protocol analysis module 416 feeds into the protocol look-up table 420. The output of the protocol look-up table 420 connects to the extraction unit 424. The output of the extraction unit 424 connects to the table device 428. The output of the table device 428 connects to the admission control unit 432, and the admission control unit connects to the output processing module 440.

The packet protocol analysis module 416 may comprise a state machine, a processor with associated software, a register with associated comparator and counter, CPU with appropriate software, or any other apparatus or system configured to extract information regarding the configuration of a data item.

The extraction unit 424 may comprise a state machine, a processor with associated software, a register with associated comparator and counter, CPU with appropriate software, or any other apparatus or system configured to extract information or data from the a data item or packet. In one embodiment the extraction unit 424 extracts a search key and is controlled at least in part by the protocol look-up table output.

The protocol look-up table 420 and the look-up 428 device may comprise any type of content addressable memory, a processor with associated memory, logic, or any other device capable of receiving an input, matching the input to content of the device, and outputting a value associated with the match. It is contemplated that the protocol look-up table 420 and the look-up device 428 may comprise the same type device.

The admission control unit 432 comprises an optional device configured to selectively accept packets for admission to a queuing system (not shown) and the output processing 440. The admission control unit 432 may be configured to take advantage of the robust response key provided by the table device 428 and to provide any type of selective packet processing that is at least controlled in part by the output of the look-up device 428, such as the response key. The output processing unit 440 comprises standard output processing as is known in the art. An output 442 provides egress for data items.

Also shown in FIG. 5 is a CPU 446 and a user interface 448 configured to provide access for a user to populate the protocol look-up table 420 and the look-up device 428. The CPU 446 and user interface 448 may comprise any type device as contemplated to provide user input to the system 400.

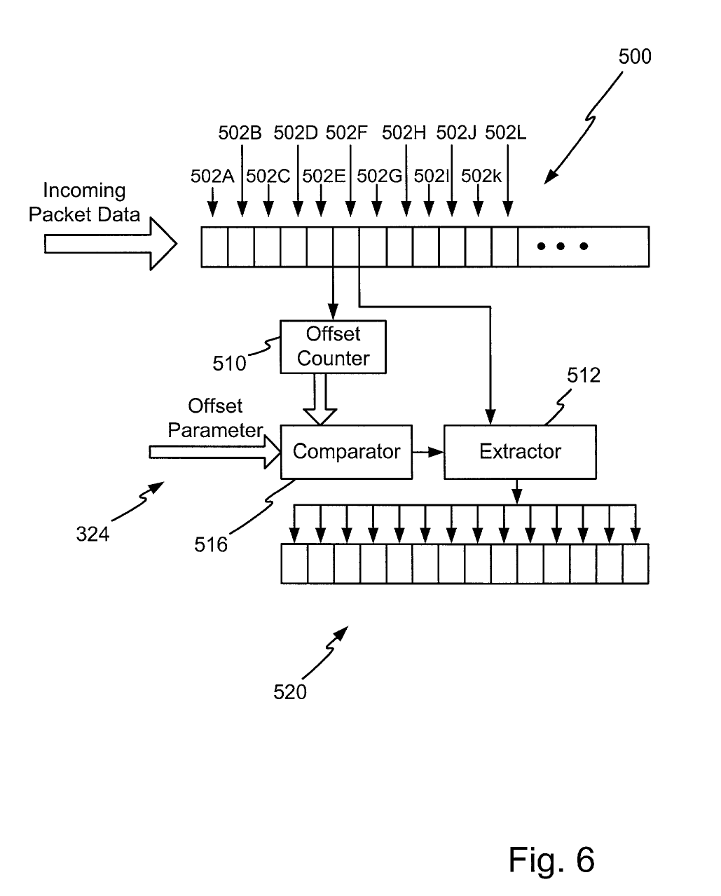

FIG. 6 illustrates a block diagram of an example embodiment of an extractor. Examples of extractors shown in FIG. 5 may include the packet protocol analysis module 416 and the extraction unit 424. The example embodiment shown in FIG. 5 is but one example embodiment of a mechanism or process to obtain or copy data from a packet or data item.

An incoming packet or data item 500 is represented as a plurality of units 502. The units of the packet may comprise any size or amount of data, such as but not limited to a bit, nibble, byte, or word. For purposes of understanding and discussion, it is assumed in this explanatory figure that the data of the packet is progressing from left to right. Thus, the data can be considered to be scrolling by the inputs to an offset counter 510 and an extractor 512. As an advantage of the invention, the invention may be configured to operate ‘on the fly’ such that as the packet data is progressing through the system, it may be processed and analyzed in accord with the teaching of the invention.

The offset counter 510 is a counter configured to increment an offset count as each unit 502 of the packet 500 progresses through the system. Thus the offset count represents the number units from the start of the packet the extractor is poised or able to extract data. The output of the offset counter feeds into a comparator 516. The comparator 516 compares the offset value against the offset parameter 324 that is also provided to the comparator. The offset parameter comprises information regarding the location, expressed as an offset from the start of a packet, at which desired information resides.

The extractor 512 is in communication with the comparator 516 and is further configured to copy or extract data from the packet. In one embodiment the comparator 516 controls when the extractor 512 copies data from the packet and forms a data string 520. The data string 520 may be of any length and is controlled by the configuration of the system, the size of each unit 502 and the number of unit(s) copied from the passing packet 500. In one embodiment the data copied from the packet may comprise the search key. In one embodiment the data copied from the packet is copied from the header.

Although the system of FIGS. 5 and 6 are described as operating on a packet, it is contemplated that the invention may analyze and process any string of data. In addition, the system of FIG. 6 may be configured to generate the protocol key. In such an embodiment the comparator 516 instructs the extractor 512 to copy data from the packet that reveals the arrangement of the data in the packet, and in particular the header. At the appropriate time or location, which may be identified by an offset, the comparator 516 controls the extractor 512 to copy the portion of the packet available at the extractor input to create a protocol key 520. It is contemplated that other methods of creating or extracting the protocol key and the search key are possible and within the scope of the invention described herein.

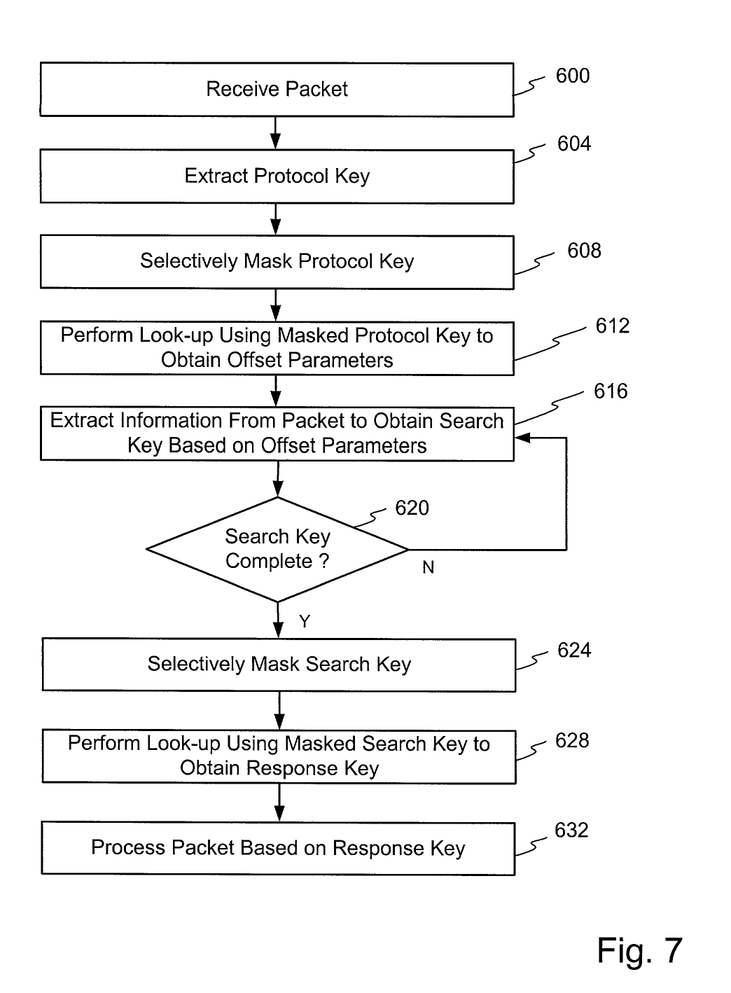

FIG. 7 illustrates an flow diagram of one example method of operation of the invention. This is one possible implementation of the invention. Other embodiments, configurations, or variations are contemplated by the inventors. This example embodiment is described in connection with packet (data item) processing as might occur in a packet switched network. Accordingly at a step 600 a packet is received for processing. Various different types of processing may occur on the packet including but not limited to processing to at least in part control packet routing, type of service provided to the packet, drop decisions, protocol handling or selection decisions, or any other processing decision as may be contemplated.

Receipt of the packet at a step 600 may include associated processing as is understood by those of ordinary skill in the art. The packet may be stored in memory or processed as it progresses through the system. Next, at a step 604 the method extracts a protocol key from the packet. In one embodiment the protocol key comprises information from the packet indicative of the protocol under which the packet was assembled or information that can reveal the location of data within the data item. The protocol of the packet may determine the location of relevant information within the header. Example protocols comprise IPv4, IPv6, DiffServ. The protocol key may be extracted from any location of the header, tag, or payload. The term tag encompasses MPLS. In one embodiment the protocol key comprises the first two bytes of the header. In other embodiments different sized portions of different parts of the header or a tag may be selected as the protocol key. At a step 608 the method may selectively mask the protocol key. Masking the protocol key provides or selects only certain portions of the protocol key to later stages of processing. Different masks may be applied based on the desired operation of the system. The mask may be controlled by a CPU, user interface, or based on the protocol of the packet and it is contemplated that the mask may be software determinable.

At a step 612 the masked protocol key is provided to a first look-up device. The first look-up device may comprises any look-up device that provides output information based on a match or closest match to inputted data, such as the protocol key. In one embodiment the first look-up device comprises a 16 position content addressable memory. Any size look-up device may be used. The look-up device performs searches for a match or the closest match to the received protocol key. Upon finding a match or closest match, the look-up device outputs a value that corresponds to or is associated with the protocol key. In one embodiment a default output is provided if an acceptable match does not occur.

The output of the first look-up device is defined as the offset parameters. In one embodiment the offset parameters define a location, specified by an offset from the start of the packet, at which the system should extract information from the packet. In one embodiment the extracted information comprises a search key. The offset may be defined as the start of the header or the start of the tag or any other position in the packet. In one embodiment the offset parameters comprise thirty-two offsets. In one embodiment the extraction processes extracts a nibble of information at each offset location. In other embodiments any number of offset may be defined and any quantity of information may be read or extracted from the packet.

At a step 616, the method begins extracting information from the packet at the locations defined by the offset and assembling the extracted information into a search key. Examples of the type of information that may be extracted include but are not limited to source address, destination address, type of service information, TCP/UDP source port, TCP/UDP destination port, IP protocol byte, and packet size information. Next, at step 620 the method determines if it has completed extraction of the search key data from the packet. If the process is not completed, the operation returns to step 616 and the extraction process continues. If at step 620 the operation is complete, then the method advances to step 624. In an alternative method of operation the header data is sequentially analyzed as the packet enters or is processed by the system. The search key or the protocol key is extracted as the data is sequenced through the system. Thus, in such an embodiment step 620 is complete when the packet or header has sequenced through the extraction system.

At step 624, the method may selectively mask the search key. Masking the search key selects only portions of the search key for use by subsequent portions of the system. The masking may be software determinable or controlled, such as for example by system software at the time the search key is obtained.

After the search key is optionally masked, the method provides the masked search key to a second look-up device. This occurs at step 628. In another embodiment a single look-up device replaces both the first look-up device and the second look-up device. The second look-up device may comprise a content addressable memory. The second look-up device performs a look-up, using the search key as the look-up key to find a match or a closest match. If a match or a closest match is found, the second look-up device outputs an associated or corresponding entry. A default entry may be output if a match or sufficiently close match does not occur. If a match or closest match is not found, then the look-up device may output a default value. The first and/or second look-up device may be programed via a user or CPU interface.

The output of the second look-up device may comprise a response key. In one embodiment the response key comprises information used to at least partially control processing of the packet. Thus, at step 632, the method processes the packet based on the response key. Processing may comprises assigning the packet to one or more of a plurality of queues, wherein each queue is assigned a different transmit priority. In other embodiments or methods the output of the look-up device comprises information used for packet processing other than packet routing.

It will be understood that the above described arrangements of apparatus and the method therefrom are merely illustrative of applications of the principles of this invention and many other embodiments and modifications may be made without departing from the spirit and scope of the invention as defined in the claims.

We claim:

1. A method for processing a packet to determine packet routing information comprising:
receiving a packet, the packet comprising a header and a payload;
copying at least a portion of the header;
inputting the at least a portion of the header into a look-up device, the look-up device configured to output header data extraction parameters to control the extraction of packet processing control data from the header of the packet;
copying at least a portion of the header to obtain packet processing control data, the portions copied controlled at least in part by the header data extraction parameters; and
inputting the packet processing control data into a content addressable memory, the content addressable memory configured to output packet processing information to control processing of the packet.

2. The method of claim 1, wherein the header contains packet protocol information.

3. The method of claim 1, wherein header data extraction parameters comprise one or more offset values from the beginning of the packet header.

4. The method of claim 1, wherein copying at least a portion of the header further comprises copying at least a portion of a tag.

5. The method of claim 1, wherein the look-up device and the content addressable memory are embodied in a single content addressable memory device.

6. The method of claim 1, further including masking the header.

7. A method for identifying a protocol and generating a search key comprising:
extracting a portion of a data item to obtain protocol information;
providing the protocol information to a first look-up device to obtain data item configuration information;
extracting processing information from the data item based on the data item configuration information; and
providing the processing information to a second look-up device to obtain data item handling information.

8. The method of claim 7, further including applying a first mask to the protocol information prior to providing the protocol information to the first look-up device to obtain data item configuration information and applying the second mask to the processing information prior to providing the processing information to a look-up device to obtain data item handling information.

9. The method of claim 7, wherein a look-up device comprises a content addressable memory.

10. The method of claim 7, wherein the data item comprises a packet and the processing information comprises at least a destination address.

11. The method of claim 7, wherein extracting protocol information comprises copying at least a portion of the first byte of the data item.

12. A method for generating a search key for use in packet processing comprising:
analyzing a packet to obtain a protocol key, the protocol key representative of the packet's protocol, the protocol controlling packet header configuration;
performing a look-up using the protocol key to obtain one or more offset parameters;
extracting information from the packet based on the one or more offset parameters to form a search key; and
performing a look-up based on the search key to obtain information regarding how to process the packet.

13. The method of claim 12, wherein the protocol is selected from the group consisting of IPv4, IPv6, and DiffServ.

14. The method of claim 12, wherein the offset parameters comprise an plurality of values that represent one or more offsets from the start of the packet.

15. The method of claim 12, further including designating the packet to one or more of a plurality of different transmit priority queues based on the information regarding how to process the packet.

16. The method of claim 12, wherein at least one performing a look-up occurs using a content addressable memory.

17. The method of claim 12, wherein the protocol key comprises at least a portion of the first two bytes of a header of the packet.

18. A system for extracting header data from a packet, the extracted header data selected for use in processing the packet, the system comprising:
a first state machine configured to extract protocol data from the packet;
a first look-up device in communication with the first state machine configured to match the protocol data to obtain offset parameters;
a second state machine configured to receive the offset parameters and extract search key data from the packet based on the offset parameters;
a second look-up device in communication with the second state machine configured to match the search key data to obtain packet processing control data.

19. The system of claim 18, wherein the first look-up device comprises discrete logic and the second look-up device comprises one or more content addressable memories located on one or more integrated circuits separate from the system for extracting header data.

20. The system of claim 18, wherein the first and second state machines comprise a single state machine.

21. The system of claim 18, further including a ternary content addressable memory configured to mask either of the protocol data or the offset parameters.

22. The system of claim 18, further including memory configured to store the packet and to be accessible by the first state machine and the second state machine.

23. The system of claim 18, wherein the offset parameters define locations within the packet of the search key data.

24. The system of claim 18, wherein the protocol data defines the type of protocol used to construct the packet.

25. A system for determining the location of data in a header of a data item comprising:
a register configured to store a portion of header data of a data item;
control logic connected to the register and configured to selectively input the data stored in the register into a table device;
a table device loaded with various combinations of header data and associated location data, wherein the location data reveals the location of data useful for data item processing within the data item.

26. The system of claim 25, further including a memory to store the data item, the register being in communication with the memory.

27. The system of claim 25, further including a masking unit configured to mask a portion of the header data.

28. The system of claim 25, further including a processing unit connected to the table device and configured to load the table device.

29. The system of claim 25, wherein the location data comprises one or more offsets from the start of the data item.

30. A search key generation apparatus comprising:
means for receiving a data item;
means for providing a portion of the data item containing data item protocol information to one or more look-up devices to obtain data location information; and
means for extracting portions of the data item based on the data location information to generate a search key.

31. The apparatus of claim 30, wherein the data item comprises a packet.

32. The apparatus of claim 30, wherein means for extracting portions of the data item based on the data location information to generate a search key comprises means for extracting type of service information.

33. The apparatus of claim 30, further including means for providing the search key to a content addressable memory to obtain data item processing information.
